(19) United States
(12) Patent Application Publication
(10) Pub. No.: US 2007/0229451 A1
(43) Pub. Date: Oct. 4, 2007

(54) Liquid crystal display device improved in white balance of display

(75) Inventor: Tetsuya Kusuno, Iruma-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/729,415

(22) Filed: Mar. 28, 2007

(30) Foreign Application Priority Data
Mar. 28, 2006 (JP) 2006-087416

(51) Int. Cl. G09G 3/36

(52) U.S. Cl. 345/102

(57) ABSTRACT

A surface illuminant device to be set as a backlight of a liquid crystal display panel has a light guide plate and LEDs. The LEDs each include LED chips for emitting rays of light having wavelengths of red, green, and blue, which are each driven by an LED drive control circuit. The LED drive control circuit supplies drive currents to the respective LED chips through an LED driver, according to the ratio of light emission intensities among rays of light to be emitted from the LED chips, which is calculated by a computing unit based on a ratio among transmissivities which stored memory, when passing through the liquid crystal display panel, of the rays of light having their own wavelengths, and a memory-stored ratio of intensities among rays of light having their own wavelengths required in order that a white display is obtained by each LED itself.

### BACKGROUND OF THE INVENTION

1. Field of the Invention

The present invention relates to a liquid crystal display device which can achieve improved white balance of display.

2. Description of the Related Art

Conventionally, a liquid crystal display device has not been suitable for displaying fast-moving images such as sports videos, etc., because they are slower in response speed than CRT displays. The most effective way to improve the response speed of a liquid crystal display device is to make the liquid crystal layer thin. In this case, if the liquid crystal layer is thinned in a twisted nematic liquid crystal display element, it becomes difficult to obtain the optimum value of the product Δn·d between the refractive anisotropy Δn of the liquid crystal and the thickness d of the liquid crystal layer, decreasing the maximum transmissivity of light for making a bright display (hereinafter referred to as maximum transmissivity). Hence, in order to improve the response speed of a liquid crystal display device, a homogeneous liquid crystal display device, whose maximum transmissivity can be achieved at a smaller value of Δn·d than that of a twisted nematic liquid crystal display element, is used, as disclosed in Unexamined Japanese Patent Application KOKAI Publication No. 2002-14333.

Liquid crystal display elements of these types have a problem that a white display of a fine quality is difficult to obtain, due to the dependency of light transmissivity on wavelength.

As a measure for reducing the wavelength dependency of light transmissivity, a so-called multigap structure, in which the liquid crystal layer thickness (gap) is differently optimized for the pixels of respective colors, is used, as disclosed in Unexamined Japanese Patent Application KOKAI Publication No. 2002-14333 mentioned above. However, to employ a multigap structure in a liquid crystal display element whose liquid crystal layer is thin makes the formation of a film for adjusting the liquid crystal layer thickness difficult and requires many steps, making a liquid crystal display device hard to manufacture.

### SUMMARY OF THE INVENTION

An object of the present invention is to provide a liquid crystal display device which can achieve improved white balance of display.

To achieve the above object, a liquid crystal display device according to a first aspect of the present invention comprises:

a liquid crystal display panel which is formed of a pair of transparent substrates between which a liquid crystal layer is sandwiched, and which performs display by controlling transmissivity of light that enters the liquid crystal layer from a side of one transparent substrate and passes through the liquid crystal layer; and

a light source comprising an n number (n being a natural number equal to or larger than 2) of light emitting elements for emitting rays of light having different wavelength ranges from each other, for emitting an n number of rays of light having their own wavelengths from the light emitting elements respectively, so that mixture light having a predetermined color, which is generated from these emitted rays of light having their own ranges being mixed, is emitted toward the liquid crystal display panel, the n number of rays of light satisfying

B1:B2: . . . :Bn=A1/T1:A2/T2: . . . :An/Tn

where transmissivities, when passing through the liquid crystal display panel, of the n number of rays of light having their own wavelengths emitted from the n number of light emitting elements respectively, are represented by T1, T2, . . . , and Tn respectively, a ratio of these transmissivities is represented by T1:T2: . . . :Tn,

intensities of the n number of rays of light having their own wavelengths emitted from the n number of light emitting elements, which intensities are required in order that a color of mixture light obtained from the n number of rays of light having their own wavelengths being mixed becomes a predetermined color, are represented by A1, A2, . . . , and An respectively, and a ratio of these intensities is represented by A1:A2: . . . :An, and

intensities of the n number of rays of light having their own wavelengths, which are to be emitted from the n number of light emitting elements toward the liquid crystal display panel are represented by B1, B2, . . . , and Bn respectively, and a ratio of these intensities is represented by B1:B2: . . . :Bn.

A liquid crystal display device according to a second aspect of the present invention comprises:

a liquid crystal display panel which is formed of a pair of transparent substrates between which a liquid crystal layer whose liquid crystal molecules are arranged in homogeneous alignment is sandwiched, and which performs display by controlling transmissivity of light that enters the liquid crystal layer from a side of one transparent substrate and passes through the liquid crystal layer;

a light source comprising an n number (n being a natural number equal to or larger than 2) of light emitting elements for emitting rays of light having different wavelength ranges from each other, for emitting mixture light having a predetermined color obtained from these emitted rays of light having their own ranges being mixed, toward the liquid crystal display panel; and

a light source control device which controls light emission intensities of the n number of light emitting elements, in a manner that

B1:B2: . . . :Bn=A1/T1:A2/T2: . . . :An/Tn

is satisfied,

where transmissivities, when passing through the liquid crystal display panel, of an n number of rays of light having their own wavelengths emitted from the n number of light emitting elements are represented by T1, T2, . . . , and Tn respectively, and a ratio of these transmissivities is represented by T1:T2: . . . :Tn,

intensities of the n number of rays of light having their own wavelengths, which intensities are required in order that a color of mixture light emitted from the light source solely, obtained from the n number of rays of light having their own wavelengths being mixed becomes the predetermined color, are represented by A1, A2, . . . , and An respectively, and a ratio of these intensities is represented by A1:A2: . . . :An, and

light emission intensities of the n number of rays of light having their own wavelengths which are to be emitted from the n number of light emitting elements toward the liquid crystal display panel are represented by B1, B2, . . . , and Bn respectively, and a ratio of these intensities is represented by B1:B2: . . . :Bn.

A liquid crystal display device according to a third aspect of the present invention comprises:

a liquid crystal display panel which is formed of a pair of transparent substrates between which a liquid crystal layer whose liquid crystal molecules are arranged in homogeneous alignment is sandwiched, and which performs display by controlling transmissivity of light that enters the liquid crystal layer from a side of one transparent substrate and passes through the liquid crystal layer;

a tri-wavelength light source which comprises three light emitting elements for emitting rays of light having three wavelength ranges of red, green, and blue respectively, for emitting mixture light having a substantially white color, obtained from the emitted rays of light having their own ranges being mixed, toward the liquid crystal display panel; and

a light source control device which controls light emission intensities of the light emitting elements of red, green, and blue in a manner that

Br:Bg:Bb=Ar/Tr:Ag/Tg:Ab/Tb

is satisfied,

where maximum values of transmissivities, when passing through the liquid crystal display panel, of the rays of light having the three wavelength ranges emitted from the light emitting elements of red, green, and blue are represented by Tr, Tg, and Tb respectively, and a ratio of these transmissivities is represented by Tr:Tg:Tb,

intensities of rays of light having the three wavelength ranges, which intensities are required in order that a color of mixture light emitted from the light source solely, obtained from the rays of light having the three wavelength ranges being mixed becomes a substantially white color are represented by Ar, Ag, and Ab respectively, and a ratio of these intensities is represented by Ar:Ag:Ab, and

light emission intensities of the rays of light having the three wavelength ranges, which are to be emitted from the light emitting elements of red, green, and blue toward the liquid crystal display panel are represented by Br, Bg, and Bb respectively, and a ratio of these intensities is represented by Br:Bg:Bb.

According to these inventions, it is possible to improve white balance of a displayed color.

### BRIEF DESCRIPTION OF THE DRAWINGS

These objects and other objects and advantages of the present invention will become more apparent upon reading of the following detailed description and the accompanying drawings in which:

FIG. 1 is an exemplary cross sectional diagram showing a liquid crystal display device as one embodiment of the present invention;

FIG. 2 is an exemplary cross sectional diagram showing a principal part of the liquid crystal display device shown in FIG. 1 in enlargement;

FIG. 3 is a schematic structure diagram showing the structure of a surface illuminant device of the liquid crystal display device shown in FIG. 1;

FIG. 4 is a spectral distribution diagram showing the spectral distribution of light emitted from an LED 15 of the liquid crystal display device, and the spectral distribution of light emitted from a liquid crystal display panel 4 with the luminance of each element of the LED 15 controlled; and

FIG. 5 is a CIE color diagram showing chromaticity coordinates of light emitted from the light source and chromaticity coordinates of light emitted from the panel.

### DETAILED DESCRIPTION OF THE PREFERRED EMBODIMENT

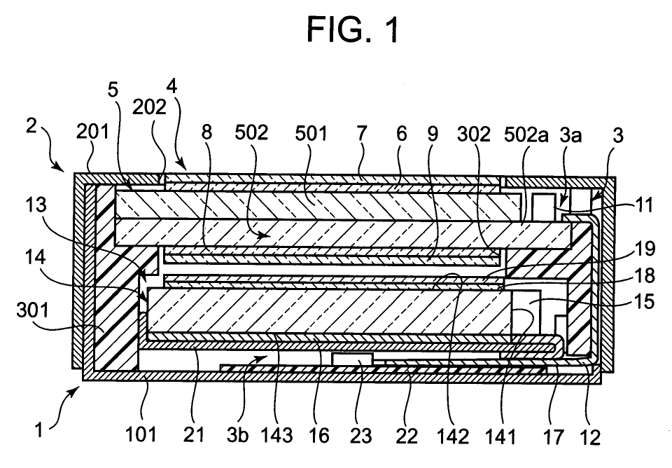

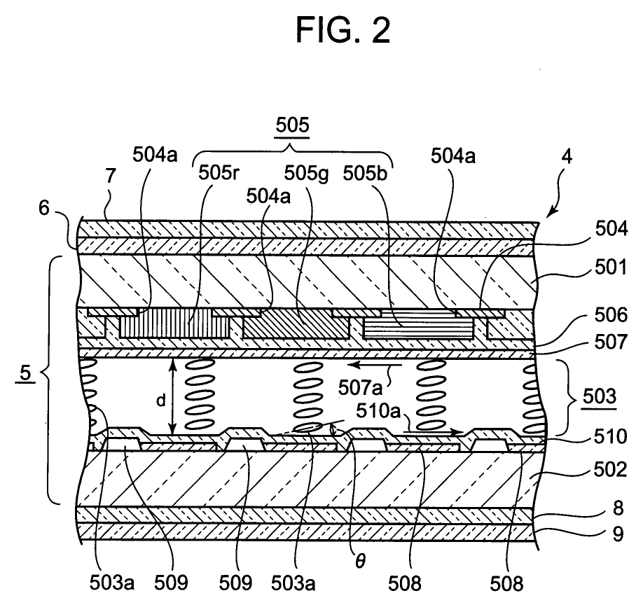

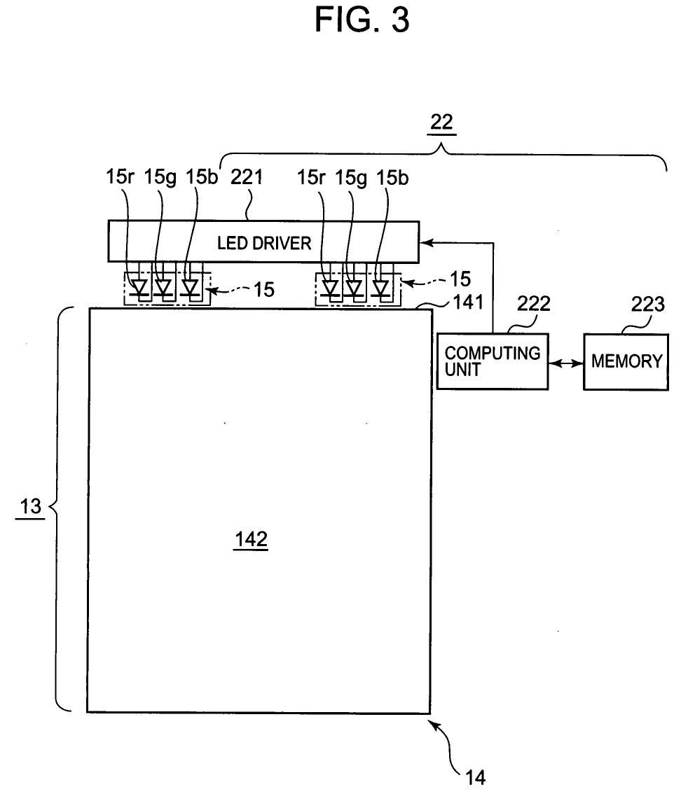

FIG. 1 shows a cross sectional structure of a homogeneous liquid crystal display device as one embodiment of the present invention. FIG. 2 shows the structure of a part of a liquid crystal display panel of the liquid crystal display device. FIG. 3 shows the structure of a surface illuminant device of the liquid crystal display device.

As shown in these diagrams, the housing of the liquid crystal display device of the present invention is formed by a storage case 1 which has a shape of a flat rectangular-parallelepiped box whose ceiling is removed, and a cover case 2 which is fitted over the storage case 1 and whose bottom is removed. The liquid crystal display panel is stored between the storage case 1 and the cover case 2. The cases 1 and 2 are both formed by working a metal plate. A display window 202 from which a display is viewed is opened in the ceiling 201 of the cover case 2.

A frame 3 is disposed inside the housing. A front chamber 3a and a rear chamber 3b, each of which defines a flat rectangular-parallelepiped space, are formed in this frame 3. That is, a side plate 301, which forms a frame body enclosing a rectangular-parallelepiped space, has a partitioning ledge 302 projected all around its inner surface, at a predetermined height. The front chamber 3a and the rear chamber 3b are formed as separated by this partitioning ledge 302, but they are made continuous by the space surrounded by the partitioning ledge 302.

A liquid crystal display panel 4 is stored in the front chamber 3a of the frame 3. The liquid crystal display panel 4 is an active matrix liquid crystal display panel. The liquid crystal display panel 4 has a front retardation plate 6 and a front polarizing plate 7, which both have a rectangular plan-view shape, sequentially formed at its front side or the viewing side, and has a rear retardation plate 8 and a rear polarizing plate 9, which both also have a rectangular plan-view shape, sequentially formed at its rear side, such that a liquid crystal cell 5 which also has a rectangular plan-view shape is sandwiched between the front side and the rear side.

As shown in FIG. 2, the liquid crystal cell 5 has a liquid crystal layer 503 formed therein by a pair of front and rear glass substrates 501 and 502 being joined to each other with a frame-shaped sealing member (unillustrated) with a predetermined gap left therebetween, and by liquid crystal filled in the space between the front and rear glass substrates 501 and 502 enclosed by the frame-shaped sealing member.

Of the pair of front and rear glass substrates 501 and 502 joined to each other, the front glass substrate 501 at one side has a black mask 504 formed on its facing surface (inner surface), for shielding an area surrounding each pixel forming one display element from light. That is, apertures 504a are opened in a matrix arrangement in the black mask 504 so as to correspond the pixels respectively.

Red, green, and blue three kinds of color filters 505r, 505g, and 505b are formed at the apertures 504a of the black mask 504 respectively, to form a color filter layer 505. Each of the color filters 505r, 505g, and 505b has an area that is larger than that of the aperture 504a by the filter's flange portion having an appropriate width all around the circumference of the aperture 504a, so that each filter has its circumferential portion overlaid on the rim of the aperture 504a of the black mask 504.

The color filter layer 505 comprising the red, green, and blue color filters 505r, 505g, and 505b has a common electrode 506, which is made of one monolithic transparent conductive film, formed thereon so as to cover the respective color filters 505r, 505g, and 505b. A front homogeneous alignment film 507, which regulates alignment of the liquid crystal molecules, is formed on the surface of the common electrode 506. Alignment by rubbing has been applied to the surface of the front homogeneous alignment film 507, along the direction of an arrow 507a that is parallel with the left and right direction of the drawing sheet.

On the other hand, the rear glass substrate 502 has a plurality of pixel electrodes 508, which are made of a transparent conductive film, formed on its inner surface likewise in a matrix arrangement so as to correspond to the apertures 504a of the black mask 504 respectively. Thin film transistors 509 as active elements for switching purpose, are provided and connected to the pixel electrodes 508 respectively. In FIG. 2, gate, drain, and source lines for driving the pixel electrodes 508 via the thin film transistors 509, insulating films between the lines, etc. are omitted. A rear homogeneous alignment film 510 is formed uniformly so as to cover all the pixel electrodes 508, thin film transistors 509, etc. Alignment by rubbing has been applied to the rear homogeneous alignment film 510 along a direction 510a, which is parallel with but opposite to the alignment direction 507a of the front homogeneous alignment film 507.

The liquid crystal layer 503 sandwiched between the front and rear homogeneous alignment films 507 and 510 alignment-treated as described above, has its liquid crystal molecules 503a put under an alignment regulating force which is along the directions 507a and 510a of alignment applied to the homogeneous alignment films 507 and 510 respectively, so as to be in a homogeneous alignment as shown in FIG. 2, in an initial state in which no electric field is applied.

That is, the liquid crystal molecules 503a are in a homogeneous alignment in which they are arranged in parallel in a posture slightly rising from one homogeneous alignment film 507 to the other homogeneous alignment film 510 at an angle (pretilt angle) θ, along the parallel but opposite alignment directions 507a and 510a of the homogeneous alignment films 507 and 510.

In the liquid crystal display device according to the present invention, the thickness d of the homogeneous liquid crystal layer 503 is set to be thin to be about 1 to 4 μm, in order that a high response speed suitable for moving image display may be achieved. The product Δn·d between the refractive anisotropy Δn of the liquid crystal and the thickness d is set to 150 to 350 m. A sufficiently high contrast can be acquired from a homogeneous liquid crystal layer, even when Δn·d is set in such a small range. In this case, a liquid crystal material having Δn equal to or smaller than 0.15, by which a required reliability can be secured, is used for the liquid crystal layer.

As shown in FIG. 1, the pair of glass substrates 501 and 502 of the liquid crystal cell 5 of the present embodiment have a size gap, and the rear glass substrate 502 is larger than the front glass substrate 501 at the display surface side. These size-differentiated glass substrates 501 and 502 are joined to each other such that one edge of the rear glass substrate 502 projects from the corresponding edge of the front glass substrate 501. The lines led out from the electrodes and connection terminals (unillustrated) at the ends of the respective lines are laid on the projecting edge 502a of the rear glass substrate 502 to form a drive circuit section thereon. A driver LSI 11 as a drive circuit element is COG (Chip On Glass)-mounted on this drive circuit section. A flexible wiring board (FPC: Flexible Printed Circuit) 12 is electrical-conductively joined to an input terminal array formed at the leading end of the drive circuit section.

A side-light type surface illuminant device 13 is stored in the rear chamber 3b of the frame 3. The side-light type surface illuminant device 13 comprises a light guide plate 14, which is transparent and has a rectangular shape roughly corresponding to the liquid crystal display panel 4, and light emitting diodes (hereinafter referred to as LEDs) 15 as dot light sources, whose light emitting surface airtightly contacts one end surface 141 of the light guide plate 14. The light guide plate 14 has a light reflective sheet 16 formed on its rear surface 143 at an opposite side to its front surface 142, which faces the liquid crystal display panel 4. Concentric-circular convex and concave patterns (unillustrated) are formed on the rear surface 143 of the light guide plate 14, at which the light reflective sheet 16 is formed, for reflecting light, which is emitted from the LED 15 and enters the light guide plate 14 from the light incident end surface 141, toward the front surface 142.

As shown in FIG. 3, the surface illuminant device 13 has two LEDs 15 and 15, which are COF (Chip On Film)-mounted directly on a flexible wiring board 17 with their light emitting surfaces in airtight contact with the light incident end surface 141 of the light guide plate 14.

Each LED 15 comprises LED chips 15r, 15g, and 15b for red, green, and blue colors respectively, for emitting rays of light having wavelengths of red, green, and blue respectively, and is constituted as a tri-wavelength white-color dot light source, which emits light having a white color in which rays of light having wavelengths of red, green, and blue emitted from the LED chips 15r, 15g, and 15b are mixed. The intensities of rays of light having wavelengths of red, green, and blue emitted from the LED chips 15r, 15g, and 15b are adjusted by controlling drive currents for the LDC chips 15r, 15g, and 15b respectively.

As shown in FIG. 1, the light guide plate 14 has a light diffusing sheet 18 and a prism sheet 19 stacked in this order on its front surface 142. The light diffusing sheet 18 is for making the distribution of luminance of illuminant light having a surface-shaped extension emitted from the light guide plate 14 uniform. The prism sheet 19 is for making the emission destinations of the illuminant light uniform in the exact forward direction.

The surface illuminant device 13 having the above-described structure is stored in the rear chamber 3b at a predetermined position as supported by a backing panel 21. The backing panel 21 is fitted in the frame 3 so as to close the bottom of the rear chamber 3b of the frame 3.

A drive control circuit board 22 is provided on the inner surface of a bottom plate 101 of the storage case 1, at the back of the baking panel 21. The drive control circuit board 22 controls the operations of the entire liquid crystal display device, and has a drive control circuit for the liquid crystal display panel 4 and a drive control circuit for the LEDs 15 formed thereon. The flexible wiring board 12 described above, which is electrical-conductively joined to the leading end of the projecting edges 502a of the rear glass substrate 502 of the liquid crystal display panel 4, is electrically connected to the drive control circuit board 22 via a connector 23. The flexible wiring board 17, on which the LEDs 15 are COF-mounted, is soldered to the flexible wiring board 12 so as to be in electrical connection.

The drive control circuit for the LEDs 15 comprises an LED driver 221 for driving the LEDs 15, a computing unit 222, and a memory 223. Each LED 15 is driven by the computing unit 222 calculating the light emission intensities for the respective LED chips 15r, 15g, and 15b based on data written on the memory 223, and by the LED driver 221 controlling the respective LED chips 15r, 15g, and 15b.

As described above, the liquid crystal display panel 4 of the liquid crystal display device according to the present embodiment uses the homogeneous liquid crystal cell 5, whose liquid crystal layer is formed thin to be 1 to 4 μm, in order to increase the response speed while securing required light transmissivity. Then, the homogeneous liquid crystal cell 5 makes it possible to achieve the optimum white display, by compensating the wavelength dependency of the light transmissivity by controlling the ratio of intensities among rays of light having their own wavelengths emitted from the LED chips 15r, 15g, and 15b of each LED 15, according to the maximum transmissivities of rays of light having wavelengths of red, green, and blue, when passing through the homogeneous liquid crystal cell 5.

The maximum values of the transmissivities of the respective rays of light having wavelengths of red, green, and, blue emitted from the three red, green, and blue LED chips 15r, 15g, and 15b, that are observed when these rays of light pass through the homogeneous liquid crystal layer 503, are expressed as Tr, Tg, and Tb respectively, and the ratio among these values is expressed as

Tr:Tg:Tb.

The ratio of intensities among red, green, and blue rays of light, which ratio is required among the rays of light having the wavelengths of red, green, and blue emitted from the three red, green, and blue LED chips 15r, 15g, and 15b in order that these rays of light can be mixed into a white ray of light prescribed on the CIE (Commission Internationale de l'Eclairage) color diagram, is expressed as

Ar:Ag:Ab.

In this case, the ratio of intensities Br:Bg:Bb among the intensities Br, Bg, and Bb of rays of light having wavelengths of red, green, and blue, which are to be emitted toward the liquid crystal display panel 4 from the three LED chips 15r, 15g, and 15b of the respective colors, is set to satisfy

Br:Bg:Bb=Ar/Tr:Ag/Tg:Ab/Tb (1).

As described above, in the liquid crystal display panel 4 of the present embodiment, the value Δn·d of the homogeneous liquid crystal layer 503 is set to 150 to 350 nm. In this case, the ratio of maximum transmissivities among the rays of light having wavelengths of red, green, and blue varies according to the effective Δn·d values of the homogeneous liquid crystal layer 503, as shown in Table 1. Effective Δn·d is a value obtained by subtracting effective retardation of the remaining-retardation offsetting retardation plates 6 and 8 from the Δn·d value of the homogeneous liquid crystal layer 503. The wavelength λ of a red (r) ray of light is 610 nm, the wavelength λ of a green (g) ray of light is 530 nm, and the wavelength λ of a blue (b) ray of light is 470 nm.

TABLE 1

| | Ratio of Intensities between Red, |
|---|---|
| Effective Δn · d | Green, and Blue Rays of Light |
| 265 | 1.00:1.08:1.00 |
| 212 | 1.00:1.21:1.33 |
| 159 | 1.00:1.32:1.61 |

Further, the ratio of intensities among the rays of light to be emitted from each single LED 15 and having wavelengths of red, green, and blue, which ratio is required in order that the rays of light emitted from the red, green, and blue LED chips 15r, 15g, and 15b can be mixed to make a substantially white display in terms of the CIE color diagram, varies according to the characteristics of the rays of light emitted from the respective LED chips 15r, 15g, and 15b of the LED 15, as show in Table 2.

TABLE 2

| | | | | | | | Ratio of Intensities Ar:Ag:Ab |
|---|---|---|---|---|---|---|---|
| | Red Ray (R) | | Green Ray (G) | | Blue Ray (B) | | among Red, Green, and Blue |
| | Peak | Half-Value | Peak | Half-Value | Peak | Half-Value | Rays of Light from Respective |
| LED | Wavelength | Width | Wavelength | Width | Wavelength | Width | LED Chips, Required for |
| No. | [nm] | [nm] | [nm] | [nm] | [nm] | [nm] | Displaying White (C point) |
| 1 | 635 | 16 | 528 | 35 | 460 | 20 | 1.00:0.78:0.62 |
| 2 | 626 | 17 | 532 | 41 | 460 | 24 | 1.00:1.05:0.89 |

In the present embodiment, LEDs 15 of the type of No. 1 in the intensity distribution table 2, whose ratio of intensities Ar:Ag:Ab among the rays of light having wavelengths of red, green, and blue, required for achieving a substantially white display (C point) in terms of the CIE color diagram is 1.00:0.78:0.62, are used. If the effective Δn·d of the homogeneous liquid crystal layer 503 is 212 nm, the ratio of transmissivities among rays of light having wavelengths of red, green, and blue in this case is, as obvious from Table 1,

Tr:Tg:Tb=1.00:1.21:1:33.

### Hence, the ratio of intensities Br:Bg:Bb among rays of light having wavelengths of red, green, and blue, which are to be emitted from the LED chips 15r, 15g, and 15b of the respective colors, is set to, as known from the aforementioned equation (1),

$$\begin{matrix}Br \text{:} Bg \text{:} Bb = 1.00 / 1.00 \text{:} 0.78 / 1.21 \text{:} 0.62 / 1.33 \\ = 1.00 \text{:} 0.64 \text{:} 0.47 .\end{matrix} \qquad ( 2 )$$

In a case where a homogeneous liquid crystal cell 5, whose liquid crystal layer thickness d is 1 to 4 μm and whose Δn·d is 150 to 350 nm, is used as the homogeneous liquid crystal cell 5, and tri-wavelength LEDs 15 for red, green, and blue, which are the same as or similar to those described above, are used as the light source, a preferred range of the ratio of intensities Br:Bg:Bb among rays of light having wavelengths of red, green, and blue to be emitted from the LED chips 15r, 15g, and 15b of the respective colors, is

Br:Bg:Bb=1.00:(0.2 to 2.0):(0.2 to 2.0)

if the differences in light emission spectrums between LEDs of the different types shown in Table 2 and the differences in the transmissivities of the rays of light that pass through the homogeneous liquid crystal cell 5 due to the differences of the effective Δn·d shown in Table 1 are taken into consideration. To be more specific, it is preferred that the ratio of intensities Br:Bg:Bb be set to an arbitrary ratio that ranges from 1.00:0.2:0.2 to 1.00:2.0:2.0. In this case, the respective intensities Br, Bg, and Bb in the ratio of intensities Br:Bg:Bb are set such that where the intensity Br is fixed at 1, the intensities Bg and Bb take optimum values in the range of 0.2 to 2.0 respectively.

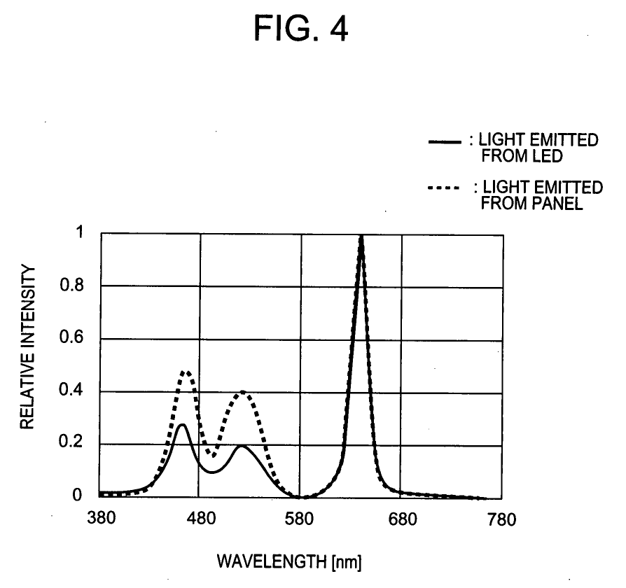

FIG. 4 shows the spectral distribution of light emitted from the LED 15 itself used in the present embodiment (with no luminance compensation) by a solid line, and shows the spectral distribution of light emitted from the liquid crystal display panel 4 (with the luminance of each element of the LED 15 controlled) by a broken line.

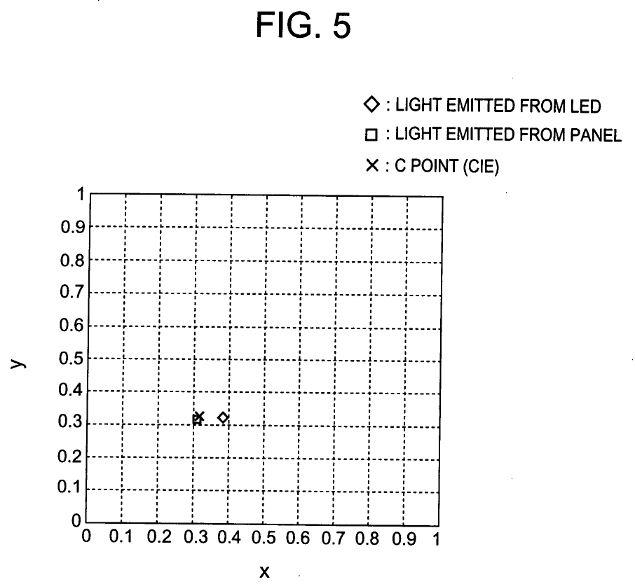

As shown in a CIE color diagram of FIG. 5, by the luminance of each element of the LED 15 being controlled, the chromaticity coordinates, indicated by symbol ⋄, of white light emitted from the LED 15 itself, in which red, green, and blue colors are mixed, can be shifted to the position of symbol □ indicating the chromaticity coordinates of light that has passed through the homogeneous liquid crystal layer 503 to generally coincide with the C point, as a white point, which is indicated by symbol x.

Since the LED chips 15r, 15g, and 15b constituting the LED 15 have individual variability in their light emission intensity, it is preferred that the values of the drive current for the respective LED chips 15r, 15g, and 15b be set to optimum ones for each liquid crystal display device.

For this purpose, in a display test for each liquid crystal display device, the transmissivities of rays of light of the respective colors when passing through the liquid crystal display panel 4 are detected, and the ratio of intensities Ar:Ag:Ab among rays of light having wavelengths of red, green, and blue in the light emitted from the LED chips 15r, 15g, and 15b of the respective colors constituting the LED 15 is obtained, so that from these values, the ratio of intensities Br:Bg:Bb among rays of light having wavelengths of red, green, and blue, which are to be emitted from the LED chips 15r, 15g, and 15b of the respective colors in order to obtain a white display of a predetermined chromaticity (C point), may be calculated based on the above-indicated equation (1). That is, the ratio of transmissivities Tr:Tg:Tb among rays of light having wavelengths of red, green, and blue and the ratio of intensities Ar:Ag:Ab among rays of light having wavelengths of red, green, and blue are written in the memory 223 of the LED drive control circuit shown in FIG. 3. The computing unit 222 calculates the ratio of intensities Br:Bg:Bb among rays of light having wavelengths of red, green, and blue, based on the ratio of transmissivities Tr:Tg:Tb and the ratio of intensities Ar:Ag:Ab among the rays of light having their own wavelengths. The LED driver 221 supplies drive currents to the LED chips 15r, 15g, and 15b of the respective colors, by controlling the values of the currents according to the ratio of intensities calculated.

As described above, the liquid crystal display device of the present embodiment uses the homogeneous liquid crystal cell 5, whose liquid crystal layer thickness is 1 to 4 μm and whose Δn·d is 150 to 350 μm, in order to increase the response speed. Further, in order to solve a problem of chromaticity shift in a white display, which is due to the wavelength dependency of the light transmissivity unique to a liquid crystal layer of homogeneous alignment, the ratio of intensities Br:Bg:Bb among rays of light emitted from the LED chips 15r, 15g, and 15b of the respective colors of the LED 15 for emitting rays of light having wavelengths of red, green, and blue is set based on the ratio of transmissivities, when passing through the homogeneous liquid crystal layer, of rays of light having the respective wavelengths and the ratio of intensities Ar:Ag:Ab among rays of light having the respective wavelengths, at which ratio light from the LED chips 15r, 15g, and 15b themselves can achieve a white display of an aimed chromaticity (C point). Therefore, a homogeneous liquid crystal display device, which has a high response speed and can achieve a favorable white display, can be obtained.

The present invention is not limited to the above-described embodiment. For example, not only the LED chips of red, green, and blue, but various combinations of light emitting elements for emitting rays of light having wavelengths of two colors or four or more colors, which can be mixed into a white ray of light, may be used as the light emitting elements for emitting rays of light having different wavelength ranges from each other.

As described above, the liquid crystal display device of the present invention comprises a liquid crystal display panel which is formed of a pair of transparent substrates sandwiching a liquid crystal layer therebetween and which performs display by controlling the transmissivity of light that enters from the side of one transparent substrate and passes through the liquid crystal layer, and a light source having an n (n being a natural number equal to or larger than 2) number of light emitting elements for emitting rays of light having different wavelength ranges from each other, for emitting the n number of rays of light having their own wavelengths, which satisfy B1:B2: . . . :Bn=A1/T1:A2/T2: . . . :An/Tn, for irradiating the liquid crystal display panel with mixture light having a predetermined color resulting from these rays of light having their own ranges being mixed, provided that the transmissivities, when passing through the liquid crystal display panel, of the n number of rays of light having their own wavelengths emitted from the n number of light emitting elements is T1, T2, . . . , and Tn respectively, the ratio of these transmissivities is T1:T2: . . . :Tn, the intensities of the n number of rays of light having their own wavelengths required in order that the mixture light generated from the n number of rays of light having their own wavelengths emitted from the n number of light emitting elements being mixed with each other may have a predetermined color are A1, A2, . . . , and An respectively, the ratio of these intensities is A1:A2: . . . :An, the intensities of the n number of rays of light having their own wavelengths, which are to be emitted from the n number of light emitting elements toward the liquid crystal display panel are B1, B2, . . . , and Bn respectively, and the ratio of these intensities is B1:B2: . . . :Bn.

In this liquid crystal display device, it is preferred that the light source be constituted by a white light source, which has an n number of light emitting elements, from which rays of light having their own ranges are emitted, for emitting substantially white mixture light obtained from these rays of light being mixed, toward the liquid crystal display panel. Further, it is preferred that the light source be constituted by a tri-wavelength light source comprising three light emitting elements for emitting rays of light having three wavelength ranges of red, green, and blue respectively, for emitting substantially white mixture light resulting from these rays of light having their own ranges being mixed, toward the liquid crystal display panel. In this case, it is desired that the white light source comprise three light emitting diode elements for emitting rays of light having wavelengths of red, green, and blue respectively. Further, it is desired that the ratio of intensities Br:Bg:Bb among the rays of light having wavelengths of red, green, and blue, which are to be emitted from the three light emitting diode elements toward the liquid crystal display panel be Br:Bg:Bb=1:(0.2 to 2.0):(0.2 to 2.0).

In this liquid crystal display device, it is preferred that the liquid crystal display panel comprise a liquid crystal layer whose liquid crystal molecules are aligned homogeneously. In this case, it is desired that the liquid crystal layer of the liquid crystal display panel have refractive anisotropy Δn and a liquid crystal layer thickness d, whose product Δn·d is 150 to 350 m. Further, it is desired that the liquid crystal layer of the liquid crystal display panel have a liquid crystal layer thickness d of 1 to 4 μm.

Further, the liquid crystal display device of the present invention comprises a liquid crystal display panel which is formed of a pair of transparent substrates between which a liquid crystal layer whose liquid crystal molecules are aligned homogeneously, is sandwiched, and which performs display by controlling the transimissivity of light that enters from the side of one transparent substrate and passes through the liquid crystal layer, a light source having n (n being a natural, number equal to or larger than 2) number of light emitting elements for emitting rays of light whose wavelength ranges are different from each other, for emitting mixture light having a predetermined color obtained from these rays of light having different ranges from each other being mixed, toward the liquid crystal display panel, and a light source control device for controlling the light emission intensities of the n number of light emitting elements in a manner that B1:B2: . . . :Bn=A1/T1:A2/T2: . . . :An/Tn is satisfied, provided that the transmissivities, when passing through the liquid crystal display panel, of the n number of rays of light having their own wavelengths emitted from the n number of light emitting elements is T1, T2, . . . , and Tn respectively, the ratio of these transmissivities is T1:T2: . . . :Tn, the intensities of the n number of rays of light having their own wavelengths required in order that the color of mixture light emitted from the light source solely, generated from the n number of rays of light having their own wavelengths being mixed with each other may have the predetermined color are A1, A2, . . . , and An respectively, the ratio of these intensities is A1:A2: . . . :An, the light emission intensities of the n number of rays of light having their own wavelengths, which are to be emitted from the n number of light emitting elements toward the liquid crystal display panel are B1, B2, . . . , and Bn respectively, and the ratio of these intensities is B1:B2: . . . :Bn.

In this liquid crystal display device, it is preferred that the light source be constituted by a white light source which has an n number of light emitting elements from which rays of light having their own ranges are emitted for emitting mixture light having a substantially white color obtained from these rays of light being mixed, toward the liquid crystal display panel, and the light source control device control the light emission intensities of the n number of light emitting elements, based on the transmissivities T1, T2, . . . , and Tn, when passing through the liquid crystal display panel, of the n number of rays of light having their own wavelengths emitted from the n number of light emitting elements, and the intensities A1, A2, . . . , and An of rays of light having their own wavelengths required in order that the mixture light from the single light source may have a white color. Further, it is preferred that the light source be constituted by a tri-wavelength light source comprising three light emitting elements for emitting rays of light having three wavelength ranges of red, green, and blue respectively, for emitting mixture light having a substantially white color obtained from these emitted rays of light having their own ranges being mixed, toward the liquid crystal display panel, and the light source control device control the light emission intensities of rays of light having their own wavelengths emitted from the three red, green, and blue light emitting elements, based on the ratio Tr:Tg:Tb among transmissivities, when passing through the liquid crystal display panel, of the rays of light having the three wavelength ranges of red, green, and blue respectively, and the ratio of intensities Ar:Ag:Ab among the rays of light having their own wavelengths required in order that the mixture light from the single light source, made from the rays of light having the three wavelength ranges may have a white color. In this case, it is desired that the tri-wavelength light source comprise three light emitting diode elements for emitting rays of light having wavelengths of red, green, and blue respectively. Further, it is desired that the ratio of intensities Br:Bg:Bb among rays of light having wavelengths of red, green, and blue emitted from the three light emitting diode elements toward the liquid crystal display panel be Br:Bg:Bb=1:(0.2 to 2.0):(0.2 to 2.0).

In the present liquid crystal display device, it is preferred that the liquid crystal display panel have a liquid crystal layer, whose refractive anisotropy Δn and whose liquid crystal layer thickness d make a product Δn·d of 150 to 350 m, with the liquid crystal layer thickness d set to 1 to 4 μm. Further, it is preferred that the light source control device comprises a memory for storing the ratio of transmissivities T1:T2: . . . :Tn among the n number of rays of light having their own wavelengths emitted from the n number of light emitting elements, when passing through the liquid crystal display panel and the ratio of intensities A1:A2: . . . :An among the n number of rays of light having their own wavelengths required in order that the color of mixture light from the single light source, obtained from the n number of rays of light having their own wavelengths being mixed, may be a predetermined color, a computing unit which calculates the light emission intensities of the n number of light emitting elements based on the ratio of transmissivities T1:T2: . . . :Tn when passing through the liquid crystal display panel and the ratio of intensities A1:A2: . . . :An among the light emitting elements, and a driver which controls the currents to be supplied to the n number of light emitting elements based on the calculation result of the computing unit.

Further, the liquid crystal display device of the present invention comprises a liquid crystal display panel formed of a pair of transparent substrates between which a liquid crystal layer whose liquid crystal molecules are homogeneously aligned is sandwiched, and which performs display by controlling the transmissivity of light that enters from the side of one transparent substrate and passes through the liquid crystal layer, a tri-wavelength light source comprising three light emitting elements for emitting rays of light having three wavelength ranges of red, green, and blue respectively, for emitting mixture light having a substantially white color obtained from the rays of light having the respective ranges being mixed, toward the liquid crystal display panel, and a light source control device which controls the light emission intensities of the respective red, green, and blue light emitting elements in a manner that Br:Bg:Bb=Ar/Tr:Ag/Tg:Ab/Tb is satisfied, provided that the maximum values of transmissivities, when passing through the liquid crystal display panel, of rays of light having the three wavelength ranges emitted from the red, green, and blue light emitting elements are Tr, Tg, and Tb respectively, the ratio of these transmissivities is Tr:Tg:Tb, the intensities of rays of light having the three wavelength ranges required in order that the rays of light having the three wavelength ranges, emitted from the single light source, may be mixed into mixture light having a substantially white color, are Ar, Ag, and Ab respectively, the ratio of these intensities is Ar:Ag:Ab, the light emission intensities of rays of light having the three wavelength ranges, which are to be emitted from the red, green, and blue light emitting elements toward the liquid crystal display panel are Br, Bg, Bb respectively, and the ratio of these intensities is Br:Bg:Bb.

In the present liquid crystal display device, it is preferred that the tri-wavelength light source comprise three light emitting diode elements, which emit rays of light having wavelengths of red, green, and blue respectively. Further, it is preferred that the ratio of intensities Br:Bg:Bb among rays of light having wavelengths of red, green, and blue, which are to be emitted from the red, green, and blue light emitting diode elements toward the liquid crystal display panel be Br:Bg:Bb=1:(0.2 to 2.0):(0.2 to 2.0). Further, it is preferred that the liquid crystal display panel comprise a liquid crystal layer whose refractive anisotropy Δn and whose liquid crystal layer thickness d make a product Δn·d of 150 to 350 nm, with the liquid crystal layer thickness d set to 1 to 4 μm. Further, it is preferred that the light source control device comprise a memory for storing the ratio Tr:Tg:Tb among transmissivities, when passing through the liquid crystal display panel, of three rays of light having their own wavelengths emitted from the red, green, and blue light emitting elements, and the ratio of intensities Ar:Ag:Ab among the three rays of light required in order that mixture light from the single light source, obtained from the three rays of light having their own wavelengths, may have a white color, a computing unit which calculates the values of light emission intensities of the respective red, green, and blue light emitting elements based on the ratio of transmissivities Tr:Tg:Tb when passing through the liquid crystal display panel and the ratio of intensities Ar:Ag:Ab among the light emitting elements, and a driver for controlling the currents to be supplied to the respective red, green, and blue light emitting elements based on the calculation result of the computing unit.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2006-87416 filed on Mar. 28, 2006 and including specification, claims, drawings and summary. The disclosure of the above Japanese Patent Application is incorporated herein by reference in its entirety.

What is claimed is:

1. A liquid crystal display device, comprising:
a liquid crystal display panel which is formed of a pair of transparent substrates between which a liquid crystal layer is sandwiched, and which performs display by controlling transmissivity of light that enters the liquid crystal layer from a side of one transparent substrate and passes through the liquid crystal layer; and
a light source comprising an n number (n being a natural number equal to or larger than 2) of light emitting elements for emitting rays of light having different wavelength ranges from each other, for emitting an n number of rays of light having their own wavelengths from the light emitting elements respectively, so that mixture light having a predetermined color, which is generated from these emitted rays of light having their own ranges being mixed, is emitted toward the liquid crystal display panel, the n number of rays of light satisfying
B1:B2: . . . :Bn=A1/T1:A2/T2: . . . :An/Tn
where transmissivities, when passing through the liquid crystal display panel, of the n number of rays of light having their own wavelengths emitted from the n number of light emitting elements respectively, are represented by T1, T2, . . . , and Tn respectively, a ratio of these transmissivities is represented by T1:T2: . . . :Tn,
intensities of the n number of rays of light having their own wavelengths emitted from the n number of light emitting elements, which intensities are required in order that a color of mixture light obtained from the n number of rays of light having their own wavelengths being mixed becomes a predetermined color, are represented by A1, A2, and An respectively, and a ratio of these intensities is represented by A1:A2: . . . :An, and
intensities of the n number of rays of light having their own wavelengths, which are to be emitted from the n number of light emitting elements toward the liquid crystal display panel are represented by B1, B2, . . . , and Bn respectively, and a ratio of these intensities is represented by B1:B2: . . . :Bn.

2. The liquid crystal display device according to claim 1,
wherein the light source comprises a white light source which emits mixture light having a substantially white color, obtained from rays of light having their own ranges emitted from an n number of light emitting elements being mixed, toward the liquid crystal display panel.

3. The liquid crystal display device according to claim 1,
wherein the light source comprises a tri-wavelength light source which comprises three light emitting elements for emitting rays of light having wavelength ranges of red, green, and blue respectively, for emitting mixture light having a substantially white color obtained from the emitted rays of light having their own ranges being mixed, toward the liquid crystal display panel.

4. The liquid crystal display device according to claim 3,
wherein the light source comprises three light emitting diode elements for emitting rays of light having wavelengths of red, green, and blue respectively.

5. The liquid crystal display device according to claim 4,
wherein a ratio of intensities Br:Bg:Bb among rays of light having the wavelengths of red, green, and blue which are to be emitted from the three light emitting diode elements toward the liquid crystal display panel satisfies
Br:Bg:Bb=1:(0.2 to 2.0):(0.2 to 2.0).

6. The liquid crystal display device according to claim 1,
wherein the liquid crystal display panel comprises a liquid crystal layer whose liquid crystal molecules are arranged in homogeneous alignment.

7. The liquid crystal display device according to claim 6,
wherein the liquid crystal layer of the liquid crystal display panel has a refractive anisotropy Δn and a liquid crystal layer thickness d, whose product Δn·d is set to 150 to 350 nm.

8. The liquid crystal display device according to claim 6,
wherein the liquid crystal layer of the liquid crystal display panel has a liquid crystal layer thickness d, which is set to 1 to 4 μm.

9. A liquid crystal display device, comprising:
a liquid crystal display panel which is formed of a pair of transparent substrates between which a liquid crystal layer whose liquid crystal molecules are arranged in homogeneous alignment is sandwiched, and which performs display by controlling transmissivity of light that enters the liquid crystal layer from a side of one transparent substrate and passes through the liquid crystal layer;
a light source comprising an n number (n being a natural number equal to or larger than 2) of light emitting elements for emitting rays of light having different wavelength ranges from each other, for emitting mixture light having a predetermined color obtained from these emitted rays of light having their own ranges being mixed, toward the liquid crystal display panel; and
a light source control device which controls light emission intensities of the n number of light emitting elements, in a manner that
B1:B2: . . . :Bn=A1/T1:A2/T2: . . . :An/Tn
is satisfied,
where transmissivities, when passing through the liquid crystal display panel, of an n number of rays of light having their own wavelengths emitted from the n number of light emitting elements are represented by T1, T2, . . . , and Tn respectively, and a ratio of these transmissivities is represented by T1:T2: . . . :Tn,
intensities of the n number of rays of light having their own wavelengths, which intensities are required in order that a color of mixture light emitted from the light source solely, obtained from the n number of rays of light having their own wavelengths being mixed becomes the predetermined color, are represented by A1, A2, . . . , and An respectively, and a ratio of these intensities is represented by A1:A2: . . . :An, and
light emission intensities of the n number of rays of light having their own wavelengths which are to be emitted from the n number of light emitting elements toward the liquid crystal display panel are represented by B1, B2, . . . , and Bn respectively, and a ratio of these intensities is represented by B1:B2: . . . :Bn.

10. The liquid crystal display device according to claim 9,
wherein the light source comprises a white light source which emits mixture light having a substantially white color, obtained from rays of light having their own ranges emitted from an n number of light emitting elements being mixed, toward the liquid crystal display panel, and
the light source control device controls light emission intensities of the n number of light emitting elements, based on transmissivities T1, T2, . . . , and Tn, when passing through the liquid crystal display panel, of an n number of rays of light having their own wavelengths emitted from the n number of light emitting elements, and intensities A1, A2, . . . , and An of the rays of light having their own wavelengths, which intensities are required in order that mixture light to be emitted from the light source solely has a white light.

11. The liquid crystal display device according to claim 9,
wherein the light source comprises a tri-wavelength light source which comprises three light emitting elements for emitting rays of light having three wavelength ranges of red, green, and blue respectively, for emitting mixture light having a substantially white color obtained from the emitted rays of light having their own ranges being mixed, toward the liquid crystal display panel, and
the light source control device controls light emission intensities of the rays of light having their own wavelengths emitted from the three light emitting elements of red, green, and blue, based on a ratio Tr:Tg:Tb among transmissivities, when passing through the liquid crystal display panel, of the rays of light having the wavelength ranges of red, green, and blue, and a ratio of intensities Ar:Ag:Ab among the rays of light having their own wavelengths, which intensities are required in order that a color of mixture of the rays of light having the three wavelength ranges, which is to be emitted from the light source solely, becomes a white color.

12. The liquid crystal display device according to claim 11,
wherein the tri-wavelength light source comprises three light emitting diode elements for emitting rays of light having wavelengths of red, green, and blue respectively.

13. The liquid crystal display device according to claim 12,
wherein a ratio of intensities Br:Bg:Bb among the rays of light having the wavelengths of red, green, and blue, which are to be emitted from the three light emitting diode elements toward the liquid crystal display panel satisfies
Br:Bg:Bb=1:(0.2 to 2.0):(0.2 to 2.0).

14. The liquid crystal display device according to claim 9,
wherein the liquid crystal layer of the liquid crystal display panel has a refractive anisotropy Δn and a liquid crystal display thickness d whose product Δn·d is set to 150 to 350 nm, with the liquid crystal layer thickness d of the liquid crystal layer set to 1 to 4 μm.

15. The liquid crystal display device according to claim 9,
wherein the light source control device comprises:
a memory which stores the ratio T1:T2: . . . :Tn among transmissivities, when passing through the liquid crystal display panel, of the n number of rays of light having their own wavelengths emitted from the n number of light emitting elements, and the ratio A1:A2: . . . :An among intensities of the n number of rays of light having their own wavelengths, which intensities are required in order that a color of mixture light emitted from the light source solely, obtained from the n number of rays of light having their own wavelengths being mixed, becomes a predetermined color;
a computing unit which calculates light emission intensities of the n number of light emitting elements, based on the ratio T1:T2: . . . :Tn among transmissivities when passing through the liquid crystal display panel and the ratio A1:A2: . . . :An among intensities of the light emitting elements; and
a driver which controls currents to be supplied to the n number of light emitting elements, based on a calculation result of the computing unit.

16. A liquid crystal display device, comprising:
a liquid crystal display panel which is formed of a pair of transparent substrates between which a liquid crystal layer whose liquid crystal molecules are arranged in homogeneous alignment is sandwiched, and which performs display by controlling transmissivity of light that enters the liquid crystal layer from a side of one transparent substrate and passes through the liquid crystal layer;
a tri-wavelength light source which comprises three light emitting elements for emitting rays of light having three wavelength ranges of red, green, and blue respectively, for emitting mixture light having a substantially white color, obtained from the emitted rays of light having their own ranges being mixed, toward the liquid crystal display panel; and
a light source control device which controls light emission intensities of the light emitting elements of red, green, and blue in a manner that
Br:Bg:Bb=Ar/Tr:Ag/Tg:Ab/Tb
is satisfied,
where maximum values of transmissivities, when passing through the liquid crystal display panel, of the rays of light having the three wavelength ranges emitted from the light emitting elements of red, green, and blue are represented by Tr, Tg, and Tb respectively, and a ratio of these transmissivities is represented by Tr:Tg:Tb,
intensities of rays of light having the three wavelength ranges, which intensities are required in order that a color of mixture light emitted from the light source solely, obtained from the rays of light having the three wavelength ranges being mixed becomes a substantially white color are represented by Ar, Ag, and Ab respectively, and a ratio of these intensities is represented by Ar:Ag:Ab, and
light emission intensities of the rays of light having the three wavelength ranges, which are to be emitted from the light emitting elements of red, green, and blue toward the liquid crystal display panel are represented by Br, Bg, and Bb respectively, and a ratio of these intensities is represented by Br:Bg:Bb.

17. The liquid crystal display device according to claim 16,
wherein the tri-wavelength light source comprises three light emitting diode elements for emitting rays of light having wavelengths of red, green, and blue respectively.

18. The liquid crystal display device according to claim 16,
wherein a ratio of intensities Br:Bg:Bb among rays of light having the wavelengths of red, green, and blue, which are to be emitted from the light emitting diode elements of red, green, and blue toward the liquid crystal display panel satisfies
Br:Bg:Bb=1:(0.2 to 2.0):(0.2 to 2.0).

19. The liquid crystal display device according to claim 16,
wherein the liquid crystal layer of the liquid crystal display panel has a refractive anisotropy Δn and a liquid crystal layer thickness d whose product Δn·d is set to 150 to 350 nm, with the liquid crystal layer thickness d of the liquid crystal layer set to 1 to 4 μm.

20. The liquid crystal display device according to claim 16,
wherein the light source control device comprises:
a memory which stores the ratio Tr:Tg:Tb among transmissivities, when passing through the liquid crystal display panel, of three rays of light having their own wavelengths emitted from the light emitting elements of red, green, and blue, and the ratio Ar:Ag:Ab among intensities of the three rays of light having their own wavelengths, which intensities are required in order that mixture light emitted from the light source solely, obtained from these three rays of light having their own wavelengths being mixed has a white color;
a computing unit which calculates value of light emission intensities of the light emitting elements of red, green, and blue, based on the ratio Tr:Tg:Tb among transmissivities when passing through the liquid crystal display panel and the ratio Ar:Ag:Ab among intensities of the light emitting elements; and
a driver which controls currents to be supplied to the light emitting elements of red, green, and blue, based on a calculation result of the computing unit.
